(19) United States
(12) Patent Application Publication
(10) Pub. No.: US 2026/0280151 A1
(43) Pub. Date: Sep. 17, 2026

(54) ANTENNA ELEMENT

(71) Applicant: Cellmax Technologies AB, Kista (SE)

(72) Inventors: Johan LUNDGREN, Storvreta (SE); Anders HAEGERMARCK, Trångsund (SE); Dan Karlsson, Sollentuna (SE)

(21) Appl. No.: 19/472,665

(22) PCT Filed: Apr. 5, 2024
(86) PCT No.: PCT/SE2024/050320

§ 371 Date: Oct. 4, 2025

(30) Foreign Application Priority Data
Apr. 5, 2023 (SE) 2350397-2

(51) Int. Cl. H01Q 21/26; H01Q 1/24; H01Q 1/52

(52) U.S. Cl. CPC H01Q 21/26; H01Q 1/246; H01Q 1/521

(57) ABSTRACT

Antenna element (1) for a multi-radiator antenna arrangement, the antenna element comprising a conductive antenna element (2) body having radiating portions (3a-d), the antenna element further comprising a feeding network electrically connected to the radiating portions, the feeding network comprising transmission lines, each having a central conductor (4a-d) and a ground conductor (5a-d), wherein the ground conductor partially surrounds the central conductor and is formed integrally with the antenna element body.

### TECHNICAL FIELD

The present invention relates to the field of base station antennas for mobile communication.

### BACKGROUND

Base station antennas for mobile communication normally comprise an antenna feeding network, a backplane and a plurality of antenna elements/radiating elements (for example dipoles) arranged in front of the backplane. The backplane typically comprises an electrically conductive reflector onto which, or in front of which, the radiating elements are arranged.

The antenna elements are commonly placed as an array in front of the backplane, in some cases as a one-dimensional array extending in the vertical direction, but two-dimensional arrays are also used.

The purpose of the antenna feeding network is to distribute the signals from a common connector to all radiating elements of an array when transmitting and combining the signals from all the radiating elements to the same common connector when receiving. Such an antenna feeding network can be realized using flexible coaxial cables using e.g. PTFE as dielectric between inner and outer conductor, or air-filled coaxial lines as disclosed in WO2005/101566A1, or stripline technology with a flat conductor being placed between two ground planes, or microstrip technology using a flat conductor placed over a ground plane, or any other transmission line technology or a combination of the technologies cited above. In all those cases, it is possible to use a dielectric as e.g. PTFE between the conductor and the ground plane, or just air. The latter will result in significantly lower losses.

As the number of frequency bands used for mobile communication, e.g. as defined by 3GPP, has increased over the years, it has become advantageous to use wide-band antenna arrays which can be used for several frequency bands. One such wideband antenna array can be used for instance be used for frequency bands below 1 Ghz (such as within the 600-1000 MHz range), another antenna array could be used for frequency bands within the frequency range 1-3 GHz (such as 1400-2700 MHz). Arrays for other frequency ranges could also be used. In order to reduce the number of antennas at the same site, arrays for different frequency ranges are often combined into a multi-band antenna.

Such multi-band antennas can be implemented using antenna feeding networks as disclosed in WO2005/101566A1. An example of a multi-band antenna is disclosed in WO2014/120062A1, which antenna comprises one low-band array and two high-band arrays arranged side by side in the form of columns of radiators. The common reflector/backplane and the feeding networks are all formed from a single extruded aluminum profile.

It is also known in the art to combine low-band and high-band radiating elements into combined antenna elements (also referred to as dual-band antenna elements), each combined antenna element having low-band radiating parts and high-band radiating parts. Using an antenna array with such dual-band antenna elements, often in combination with low-band elements or high-band elements, instead of one array with low-band elements and one array with high-band elements may be advantageous as the dimensions of the antenna may be reduced.

U.S. Pat. No. 6,930,650B2 discloses a combined antenna element comprising an antenna element and a further antenna element for operating in a further frequency band, the further antenna element being arranged in the interior of the antenna element. The antenna element comprises at least four antenna element devices separated by gaps. The antenna element devices are fed at the respective end of the gaps by coaxial cables. Such feeding using coaxial cables soldered to the antenna element devices at the ends of the gaps requires time-consuming assembly and may result in passive intermodulation (PIM). Further, in order to solder coaxial cables to the antenna element, it needs to be treated for example silver plated, which adds cost and time to the manufacturing. Further, such coaxial cables may be complicated to use with the above-described type of antenna feeding networks using air-filled coaxial lines or stripline/microstrip transmission lines. U.S. Pat. No. 7,079,083 (B2) discloses a similar combined antenna elements with feed points at the ends of the gaps between the antenna element devices.

### SUMMARY

An object of the invention is to provide a dual-band antenna element and an antenna element suitable for such a dual-band antenna element (i.e. an antenna element with a suitable shape for combing with antenna elements for a different frequency range) or usable as a single-band element which solves or at least improves on the problems identified above.

These and other objects are achieved by the present invention by means of an antenna element according to the independent claim, a dual-band antenna element arrangement comprising such an antenna element and a multi-radiator antenna arrangement comprising such an antenna element and/or dual-band antenna element arrangement.

According to a first aspect of the invention, there is provided an antenna element for a multi-radiator antenna arrangement, the antenna element comprising a conductive antenna element body having radiating portions, the antenna element further comprising a feeding network electrically connected to the radiating portions, the feeding network comprising transmission lines, each having a central or inner conductor and a ground conductor, wherein the ground conductor partially surrounds the central conductor and is formed integrally with the antenna element body.

The invention is based on the insight that by providing the antenna element with an integrated feeding network with the ground/outer conductors thereof formed integrally with the antenna element body (i.e. the ground/outer conductors are integrated in the antenna element body), an antenna element with low losses in its feeding network can be obtained, and which is also easy to assemble and to integrate as part of an antenna arrangement with a reflector/antenna feeding network of the coaxial air-filled type presented in applicant's earlier patent applications.

It is understood that radiating portions may refer to portions of one or more common parts, i.e. two or more, or all radiating portions are formed as portions of one or more common antenna element body parts. For example, all radiating portions may be formed as portions of one integrally formed antenna element body. Alternatively, radiating portions may refer to separate radiating parts, i.e. an antenna element body being formed from a plurality of antenna element body parts. It is understood that the ground conductor partially surrounding the central conductor refers to the ground conductor not fully surrounding/encircling the central conductor in the sense of a coaxial line but surrounding/encircling at least part of the central conductor, for example in the form of a U-shaped compartment in which the central conductor is arranged.

In embodiments, the antenna element body may be integrally formed, for example casted in aluminum or zink, or machined from hot pressed aluminum.

In embodiments, at least one non-conductive holding element is arranged to hold the central conductors in position in relation to the ground conductors.

In embodiments, the transmission lines of the feeding network are capacitively and/or inductively connected to the radiating portions. Such capacitive and/or inductive connection to the radiating portions may be achieved by means of an insulating coating/layer on the inner conductors and/or by means of the at least one non-conductive holding element also being configured to hold the inner conductors in position and act as an insulating layer in relation to the radiating portions.

In embodiments, the antenna element body comprises said radiating portions in the form of radiating portions formed spaced apart from each other at a periphery of the antenna element. The radiating portions may be radiating edges of the antenna element body. For example, the antenna element body may comprise four radiating portions or edges, which may be arranged substantially perpendicularly to each other. In such embodiments, the radiating portions or edges may be substantially straight, i.e. the antenna element body has a substantially rectangular or quadratic shape. The length of the radiating portions or edges may be between 20% and 60% of a wavelength of the center frequency of an operating frequency range of the antenna element. The radiating portions or edges may be spaced apart by slots in the antenna element body, which slots may be described as substantially radially extending as seen from a center of the antenna element body.

In embodiments, the transmission lines of the feeding network are capacitively and/or inductively connected to the radiating portions or edges by means of one of the central conductors crossing each slot. The central conductors of the transmission lines may be arranged to cross the respective slot at positions being at a distance from the radiating portions/edges, i.e. being at a distance from the periphery of the antenna element body.

In embodiments, the slots have an electrical length as seen from the crossings of the central conductors which correspond to 0.15 to 0.35, such as one quarter of a wavelength of the center frequency of an operating frequency range of the antenna element. Such an electrical length means that a balancing device is formed where signals fed to the slot progressing inwardly along the slot are cancelled out. It is understood that electrical length (or effective length) is the length seen electrically, which length does not necessarily correspond to the physical length of the slot. The difference may relate to the shape of the slot, which may for example be “T-shaped” rather than straight as explained below with reference to the figures. Also, in some cases, impedance matching of the radiator may be improved if the electrical length differs slightly from the theoretical quarter wavelength value.

In embodiments, the slots are each formed by at least a first slot portion and a second slot portion, the second slot portion being at a distal end of the slot as seen from the corresponding radiating portions/edges and having a greater width than the first slot portion. In other words, the slots are T-shaped, with the second slot portion forming the “roof” of the T-shape. Such a T-shape of the slots is advantageous since the slots can be made physically shorter (as seen in radial direction) for a given electrical length. Shorter slots (lesser radial extensions) may provide the advantage that interference with a high-band antenna element arranged coaxially with the antenna element may be reduced. The slot may also have three or more sections with different widths.

In embodiments, the central conductors of the transmission lines for at least one, or each, pair of opposing radiating portions/edges are formed together as an integral part. The antenna element may thus be dual-polarized or cross-polarized. For instance, two essentially orthogonal polarizations can be exited using two different feeding points. Those polarizations may be +/−45 degrees relative the antenna length direction.

In embodiments, the feeding network comprises splitting means for splitting signals to two or more (such as four) radiating portions/edges. This embodiment is advantageously combined with the above-described embodiment comprising central conductors for pairs of opposing radiating portions/edges being formed together as an integral part, wherein the splitting means are formed as branching portions of said integral parts.

In embodiments, the antenna element body is substantially bowl-shaped. “Bowl-shaped” is to be interpreted in the sense that the antenna element body has a concave (but not necessarily strictly concave) front/inner surface, the front/inner surface referring to the surface facing forwardly/in the radiation direction of the antenna element. The bowl-shape may be formed by a bottom body portion (which may be substantially plane, thus defining a bottom plane) and a plurality of side walls extending from the edges of the bottom portion. Each side wall may be formed by at least two side wall portions being arranged at different obtuse angles relative the bottom body portion (or relative the bottom plane). The at least two side wall portions may be described as defining non-coinciding and non-parallel side wall portion planes. The side wall portion planes may alternatively be described as being arranged at different (obtuse) angles relative the bottom plane. The front/inner surfaces of the side wall portions (and the side wall portion planes) may each be described as forming an obtuse angle with the bottom plane, and forming an obtuse angle with each other. In other embodiments, the antenna element body may be substantially bowl-shaped in the sense described above, but formed by portions (such as a bottom body portion a plurality of side wall portions extending from the bottom portion) which are not plane, but on the contrary where at least one, or each, body portion is at least partly curved.

According to a second aspect of the invention, a dual-band antenna element arrangement is provided. The dual-band antenna element arrangement comprises an antenna element according to the first aspect of the invention or embodiments thereof, the antenna element being configured to transmit and receive signals within one or more first frequency bands, and a high-band antenna element configured to transmit and receive signals within one or more second frequency bands, wherein the high-band antenna element comprises radiating portions and is arranged substantially at a center of the antenna element (i.e. with coinciding center axes, i.e. coaxially) at least partly within a space defined by the antenna element body of the antenna element. The high-band antenna element may be formed as two perpendicular dipoles such as to form two cross-polarized or dual-polarized radiators having essentially orthogonal radiation planes. The one or more second frequency bands may be higher than the one or more first frequency bands. For example, the first frequency band(s) may be below 1 GHz, and second frequency band(s) may be within an interval from 1.0-3.0 GHz. Further, the one or more second frequency bands may have a center frequency F₂ being higher than a center frequency F₁ of said one or more first frequency ranges. The ratio F₂:F₁ may be larger than 1.5:1, or larger than 2:1.

In embodiments, the high-band antenna element is arranged at a bottom of the antenna element body or at a raised platform arranged at a bottom of the antenna element body, where the bottom may refer to the bottom body portion of the antenna element body.

In embodiments, the slots of the antenna element are configured in relation to the high-band antenna element such that a horizontal area projection of the high-band antenna element onto the antenna element is non-overlapping with the slots. In other words, when seen from the front in the direction of the center axes of the antenna element and high-band antenna element, the slots of the antenna element and the high-band antenna element are non-overlapping. In other words, the high-band antenna element has an outward radial extension (as seen from the center of the antenna element) lesser than the inward radial extension of the slots (as seen from the periphery of the antenna element). Such embodiments are advantageous since the non-overlap between the slots and the high-band antenna element results in reduced interference between the (low-band) antenna element and the high-band antenna element.

According to a third aspect of the invention, an antenna arrangement is provided. The antenna arrangement comprises a backplane, a plurality of antenna elements according to the first aspect of the invention or embodiments thereof and/or dual band antenna element arrangements according to the second aspect of the invention or embodiments thereof. The plurality of antenna elements and/or dual band antenna element arrangements is arranged in front of the backplane. An antenna feeding network is electrically connected to the antenna elements and/or dual-band antenna element arrangements. The antenna arrangement may further comprise high-band-only antenna elements arranged in front of the backplane and being connected to the antenna feeding network. For example, the multi-radiator antenna arrangement may comprise a plurality of dual band antenna element arrangements arranged in a column with a high-band-only antenna element (corresponding to the high-band antenna elements of the dual band antenna element arrangements) between each consecutive pair of dual band antenna element arrangements. In such an arrangement, all low band elements may be connected to a first (low-band) feeding network, and all high-band elements may be connected to a second (high band) feeding network.

In embodiments, the antenna feeding network comprises transmission lines being capacitively and/or inductively interconnected, the transmission lines being capacitively and/or inductively connected to the antenna elements and/or dual-band antenna element arrangements. The antenna feeding network may comprise a plurality of parallel transmission lines (such as coaxial lines), each comprising an inner conductor which is at least partially surrounded by an outer conductor. The outer conductors may be integrally formed with each other (and with the backplane/reflector) as an extruded aluminum profile. The transmission lines of the antenna feeding network may be interconnected with connector devices interconnecting inner conductors of at least two transmission lines. The capacitive and/or inductive interconnection is achieved by means of an insulating layer or coating arranged on a connector device and/or on the inner conductor(s) and/or in the form of an insulating film between the connector device and the inner conductor(s).

In embodiments, the dual-band antenna element arrangements are arranged in relation to said backplane such that the radiating portions of the high-band antenna element are disposed at a distance above the backplane which is less than 75%, such as less than 74%, or less than 73%, or less than 70%, or less than 60%, or less than 50%, of the distance between the radiating portions of the antenna element and the backplane.

In embodiments, the central conductor of the antenna feeding network does not have any galvanic joints.

According to a fourth aspect of the invention, an antenna arrangement is provided. The antenna arrangement comprises a backplane, at least one dual band antenna element arrangement arranged in front of the backplane, and an antenna feeding network electrically connected to the at least one dual-band antenna element arrangement. The dual band antenna element arrangements each comprise a (low band) antenna element and a high-band antenna element. At least one, or each, dual-band antenna element arrangement is arranged in relation to the backplane such that the radiating portions of the high-band antenna element are disposed at a distance above the backplane which is less than 75%, such as less than 74%, or less than 73% or less than 70%, or less than 60%, or less than 50%, of the distance between the radiating portions of the antenna element and the backplane.

In embodiments of the fourth aspect of the invention, the (low band) antenna element is configured to transmit and receive signals within one or more first frequency bands, and a high-band antenna element is configured to transmit and receive signals within one or more second frequency bands being higher than said one or more first frequency bands, wherein the high-band antenna element comprises radiating portions and is arranged substantially at a center of the (low-band) antenna element (i.e. with coinciding center axes, i.e. coaxially) at least partly within a space defined by the antenna element body of the antenna element.

In embodiments of the fourth aspect of the invention, the antenna element of the dual band antenna element arrangement comprises a conductive antenna element body having radiating portions, the antenna element further comprising a feeding network electrically connected to the radiating portions, the feeding network comprising transmission lines, each having a central conductor and a ground conductor, wherein the ground conductor partially surrounds the central conductor and is formed integrally with the antenna element body.

According to a fifth aspect of the invention, there is provided an antenna arrangement comprising at least two antenna elements and an antenna feeding network electrically connected to the at least two antenna elements, the antenna elements comprising a conductive antenna element body having radiating portions spaced apart by slots in the antenna element body. The radiating edges are fed over the slots. The antenna feeding network comprises transmission lines which connects an antenna connector to the radiating edges, wherein the central conductor of the feeding network does not have any galvanic joints. The antenna element body may be substantially bowl-shaped.

The features of the embodiments described above are combinable in any practically realizable way to form embodiments having combinations of these features. Further, all features and advantages of embodiments described above with reference to the first aspect of the invention may be applied in corresponding embodiments of the second, third, fourth and fifth aspects of the invention and vice versa.

### BRIEF DESCRIPTION OF THE DRAWINGS

Above discussed and other aspects of the present invention will now be described in more detail using the appended drawings, which show presently preferred embodiments of the invention, wherein:

FIG. 1 shows a rear/bottom view of an embodiment of an antenna element according to the first aspect of the invention;

FIG. 2 shows a perspective view from above of the antenna element in FIG. 1 shown with a bottom support and arranged on a backplane;

FIG. 3 shows a cross-section view of the antenna element in FIG. 1-2;

FIG. 4 shows a perspective view of an integrally formed central conductor of the antenna element in FIG. 1-3;

FIG. 5 shows a front/top view of an embodiment of a dual-band antenna element arrangement according to the second aspect of the invention comprising an antenna element as shown in FIG. 1-3, and

FIG. 6 shows a partial cross-section view of an embodiment of the antenna arrangement according to the third and fourth aspects invention, the cross-section being taken along a plane being parallel with the longitudinal/height direction of the antenna arrangement.

### DETAILED DESCRIPTION

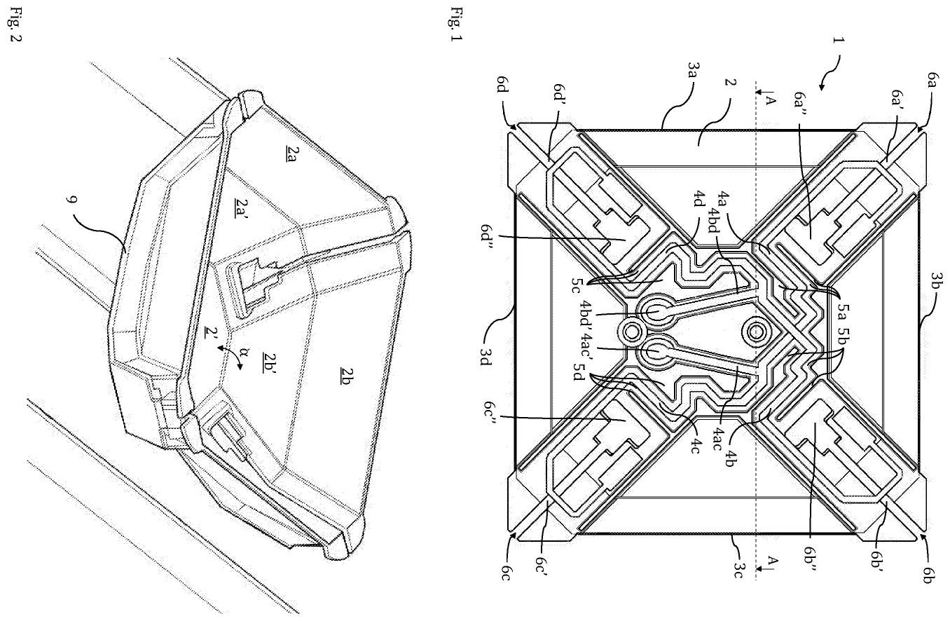

FIG. 1 shows a rear view of an embodiment of an antenna element according to the first aspect of the invention.

The antenna element 1 comprises a substantially quadratic conductive antenna element body 2 having four radiating portions 3a-d formed spaced apart from each other at a periphery of the antenna element. Each adjacent pair (3a, 3b for example) of the radiating edges are arranged perpendicularly to each other. Opposite radiating edges (3a, 3c for example) are parallel with each other. The radiating edges are spaced apart by slots 6a-d in the antenna element body 2. The slots may be described as radially extending as seen from a center of the antenna element body 2. The antenna element body 2 is integrally formed.

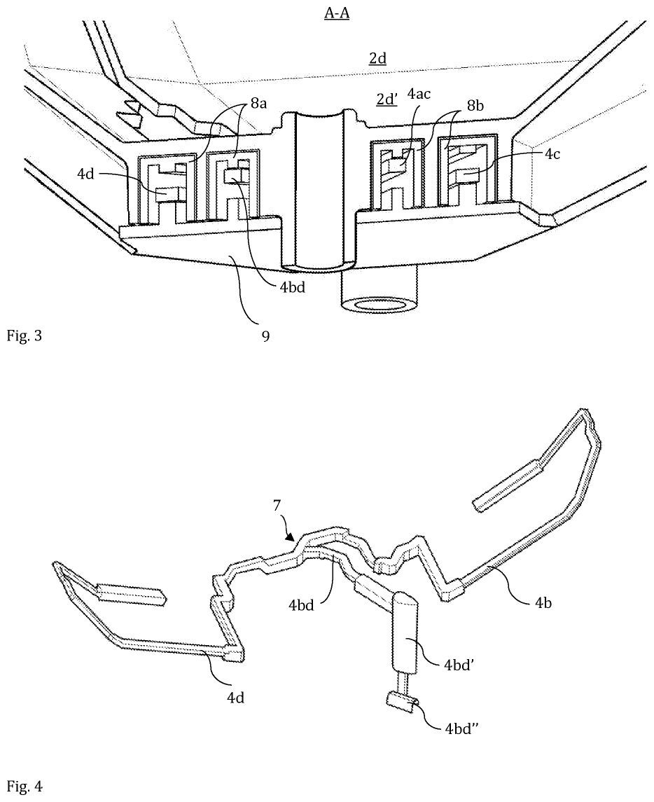

The antenna element further comprises a feeding network electrically connected to the radiating portions 3a-d, the feeding network comprising transmission lines, each having a central conductor 4a-d and a ground conductor 5a-d, the ground conductors being formed integrally with the antenna element body, i.e. the ground conductors are formed as portions of the (integrally formed) antenna element body 2. The ground conductors 5a-d partially surround the respective central conductor 4a-d by means of forming a U-shaped compartment in which the respective central conductor is arranged (see FIG. 3).

The transmission lines of the feeding network are capacitively and/or inductively connected to the radiating edges 3a-d by means of one of the central conductors 4a-d crossing a respective slot 6a-d. The central conductors of the transmission lines cross the respective slot at positions being at a distance from the radiating edges 3a-d (see FIG. 1), i.e. being at a distance from the periphery of the antenna element body.

The slots 6a-d have an electrical length as seen from the crossings of the central conductors which correspond to 0.15 to 0.35, such as one quarter, of a wavelength of the center frequency of an operating frequency range of the antenna element.

The slots 6a-d are each formed by a first slot portion 6a′-d′ and a second slot portion 6a″-d″. The second slot portion is at a distal end of the slot as seen from the corresponding radiating edges and having a greater width than the first slot portion such as to form a “T-shape” with the second slot portions 6a″-d″ forming the “roof” of the T-shape.

The central conductors 4a, 4c of the transmission lines crossing the opposing slots 6a, 6c are formed together as an integral part 4ac. Correspondingly, the central conductors 4b, 4d of the transmission lines feeding/crossing the opposing slots 6b, 6d are formed together as an integral part comprising a common conductor portion 4bd and conductor portions 4b, 4d.

The integral parts of the transmission lines comprise branching portions (ref. 7, see FIG. 4) forming splitting means for splitting signals from the common conductor portion 4ac, 4bd to the respective central conductor portions 4a/4c, 4b/4d. The integral parts also comprise a connecting portion 4ac′, 4bd′ arranged to extend rearwards through the backplane/reflector of the antenna arrangement to connect with an antenna feeding network.

FIG. 2 shows a perspective view from above of the antenna element in FIG. 1 shown with a bottom support and arranged on a backplane.

As can be seen in FIG. 2, the antenna element body is substantially bowl-shaped comprising a bottom body portion 2′ and a plurality of side walls extending from the edges of the bottom portion. Each side wall is formed by at least two consecutive non-parallel plane side wall portions (2a-a′, 2b′-b′ for example) arranged at different obtuse angles relative the bottom body portion (see for example angle α between the bottom portion and side wall portion 2b′, which angle is greater than the obtuse angle formed between the side wall portion 2b and the bottom portion 2′).

Also seen in FIG. 2 is a non-conductive bottom support 9 which covers the transmission lines seen in FIG. 1 from below and supports/holds the central/inner conductors in position in relation to the ground/outer conductors.

FIG. 3 shows a cross-section view of the antenna element in FIG. 1-2, the cross-section being taken along line A-A shown in FIG. 1. As can be seen in FIG. 3, the integrally formed central conductors are held in position in relation to the ground conductors by non-conductive holding elements 8a-b and also by the non-conductive bottom support 9 (which may also be considered a non-conductive holding element).

FIG. 4 shows a perspective view of an integrally formed central conductor 4bd, 4b, 4d of the antenna element in FIG. 1-3. The integral part comprises a branching portion 7 forming splitting means for splitting signals from the common conductor portion 4bd to the respective central conductor portions 4b, 4d. The connecting portion 4bd′ (also shown in FIG. 1) is arranged to extend backwards through the backplane/reflector of the antenna arrangement to connect with an antenna feeding network by means of snap-on portion 4bd″ which engages with the outer surface of an inner conductor of the antenna feeding network. The variations in cross-sectional area along the central conductor (as seen in FIG. 4) is for improving the impedance matching of the element.

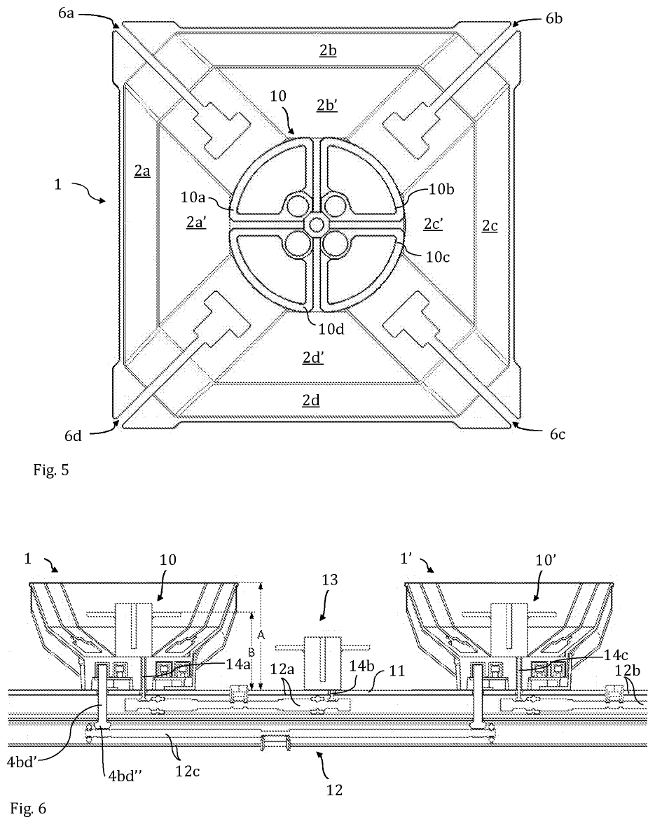

FIG. 5 shows a front view of an embodiment of a dual-band antenna element arrangement according to the second aspect of the invention comprising an antenna element as shown in FIG. 1-4, and a high-band antenna element 10 arranged coaxially within the interior of the bowl-shaped (low-band) antenna element 1 (see FIG. 6) at the bottom portion of the antenna element body 2. The antenna element 1 is configured to transmit and receive signals within one or more first frequency bands, and the high-band antenna element 10 is configured to transmit and receive signals within one or more second frequency bands. The one or more second frequency bands have a center frequency F₂ being higher than a center frequency F₁ of said one or more first frequency bands. The ratio F₂:F₁ is larger than 1.5:1. The high-band antenna element 10 is formed as two perpendicular dipoles 10a/10c and 10b/10d.

The slots 6a-d of the antenna element 1 are configured in relation to the high-band antenna element 10 such that a horizontal projection of the high-band antenna element on the antenna element is non-overlapping with the slots, i.e. In other words, when seen from the front in the direction of the center axes of the antenna element and high-band antenna element, the slots of the antenna element and the high-band antenna element are non-overlapping (as seen in FIG. 5).

FIG. 6 shows a partial cross-section view of an embodiment of the antenna arrangement according to the third and fourth aspects invention, the cross-section being taken along a plane being parallel with the longitudinal/height direction of the antenna arrangement.

The antenna arrangement comprises an antenna feeding network 12 comprising a first set of transmission lines (12a, 12b for example) and a second set of transmission lines (12c for example). The transmission lines of the first and second sets of transmission lines comprises inner conductors and outer conductors forming coaxial lines. The inner conductors have circular cross sections and are surrounded by a respective outer conductor having a substantially rectangular cross-section. The outer conductors are formed integrally with the backplane/reflector 11.

The space formed between each inner conductor and the corresponding outer conductor is substantially air-filled in the sense that solely air is provided between the inner and outer conductors except for parts such as connecting portions (4bd′ for example) and optional support elements configured to hold the inner conductors in position. The first set of transmission lines (12a, 12b for example) is located at a rear side of the backplane 11 and the second set of transmission lines (12c for example) is located at a rear side of the first set of transmission lines.

The antenna arrangement comprises a plurality of dual-band antenna element arrangements (1, 10 and 1′, 10′ for example) of the same type shown in FIG. 5 and described above. As can be seen in FIG. 6, the antenna arrangement also comprises high-band-only antenna elements (13 for example). The high-band only antenna elements correspond to the high-band antenna elements 10, 10′.

The antenna elements are arranged in a column/along a straight line to form an interleaved array of antenna elements.

The dual-band antenna element arrangements 1/10, 1′/10′ are arranged in relation to the backplane 11 such that the radiating portions (10a-d, see FIG. 5) of the high-band antenna element 10 are disposed at a distance B above the backplane which is approximately 73% of the distance A between the radiating portions (3a-d, see FIG. 1) of the antenna element and the backplane.

The high-band antenna elements 10, 10′, 13 are each connected to the first set of transmission lines 12a, 12b via coupling elements (14a-c for example) connecting to the inner conductors thereof.

Consecutive (low-band) antenna elements (1, 1′ for example) of the dual-band antenna element arrangements are connected pairwise to common inner conductors (for example of coaxial line 12c, see FIG. 6) via respective connecting portions (4bd′ for example) of each low-band antenna element. Consecutive high-band antenna elements (10, 13 for example) are connected pairwise to a common inner conductor (for example of coaxial line 12a, see FIG. 6) via respective coupling elements. As can be seen in FIG. 6, the inner conductor for the pair of high-band antenna elements 10, 13 is arranged between two of the connecting portions for the low-band radiating elements.

The low-band/high-band radiating elements are connected to the respective inner conductors capacitively and/or inductively. This is achieved by means of an insulating layer or coating arranged on the coupling elements and/or on the inner conductors and/or in the form of an insulating film between the coupling elements and the inner conductors. Further, the transmission lines of the antenna feeding network 12 are capacitively and/or inductively connected to each other.

The description above and the appended drawings are to be considered as non-limiting examples of the invention. The person skilled in the art realizes that several changes and modifications may be made within the scope of the invention. For example, the shape of the radiating portions or edges of the antenna element may be varied and may for example be curved instead of straight. Further, the number of radiating portions or edges may be varied. Furthermore, the shape of the antenna element body may be varied and may comprise further or fewer antenna element wall portions and/or wall portions arranged at different angles. It is also foreseeable that the antenna element body may be bowl-shaped but being formed as one curved/rounded part, or formed by two or more curved/rounded portions. Furthermore, the high-band antenna element may be arranged with its radiating portions at a lower height (in relation to the height of the radiation portions of the low-band antenna element) than shown. Furthermore, all antenna elements of an antenna arrangement are not necessarily connected pair-wise to transmission lines as shown and described above. The scope of protection is determined by the appended patent claims.

1. An antenna element (1) for a multi-radiator antenna arrangement, the antenna element comprising a conductive antenna element (2) body having radiating portions (3a-d), the antenna element further comprising a feeding network electrically connected to the radiating portions, the feeding network comprising transmission lines, each having a central conductor (4a-d) and a ground conductor (5a-d), wherein the ground conductor partially surrounds the central conductor and is formed integrally with the antenna element body..

2. Antenna element according to claim 1, wherein said transmission lines of the feeding network are capacitively and/or inductively connected to the radiating portions (3a-d).

3. Antenna element according to any of the preceding claims, wherein the antenna element body (2) is integrally formed.

4. Antenna element according to any of the preceding claims, wherein said antenna element body (2) comprises said radiating portions (3a-d) in the form of radiating portions formed spaced apart from each other at a periphery of the antenna element.

5. Antenna element according to claim 3 or 4, wherein the length of the radiating portions (3a-d) is between 20% and 60% of a wavelength of the center frequency of an operating frequency range of the antenna element.

6. Antenna element according to claim 4 or 5, wherein the radiating portions (3a-d) are spaced apart by slots (6a-d) in the antenna element body.

7. Antenna element according to claim 6, wherein the transmission lines of the feeding network are capacitively and/or inductively connected to the radiating portions (3a-d) by means of one of the central conductors (5a-d) crossing each slot (6a-d).

8. Antenna element according to claim 7, wherein said central conductors of the transmission lines crosses the slots at positions being at a distance from the radiating portions (3a-d).

9. Antenna element according to any of claims 6-8, wherein said slots (6a-d) have an electrical length as seen from the crossings of the central conductors which correspond to 0.15 to 0.35, such as one quarter, of a wavelength of the center frequency of an operating frequency range of the antenna element such as to form a balancing device.

10. Antenna element according to any of claim 6-9, wherein said slots (6a-d) are each formed by at least a first slot portion (6a′-d′) and a second slot portion (6a″-d″), the second slot portion being at a distal end of the slot as seen from the corresponding radiating portions and having a greater width than the first slot portion.

11. Antenna element according to any of claims 4-10, wherein the central conductors (4a,c, 4b,d) of the transmission lines for at least one pair of opposing radiating portions (3a,c, 3b,d) are formed together as an integral part (4ac, c, d, 4bd, b, d).

12. Antenna element according to any of claims 4-11, wherein the feeding network comprises splitting means (7) for splitting signals to two or more radiating portions (3b, 3d).

13. Antenna element according to claim 12 as dependent on claim 11, wherein said splitting means is formed as a branching portion of said integral part (4bd).

14. Antenna element according to any of the preceding claims, further comprising at least one non-conductive holding element (8a, 8b, 9) arranged to hold the central conductors in position in relation to the ground conductors and the antenna element body.

15. Antenna element according to any of the preceding claims, wherein the antenna element body (2) is substantially bowl-shaped.

16. Antenna element according to claim 15, wherein said bowl-shape is formed by a substantially plane bottom body portion (2′) defining a bottom plane and a plurality of side walls extending from the edges of the bottom portion, each side wall being formed by at least two substantially plane side wall portions (2a, 2a′, 2b, 2b′, 2c, 2c′, 2d, 2d′) defining respective side wall portion planes forming a respective obtuse angle (9) relative the bottom plane.

17. Antenna element according to any of the preceding claims, wherein adjacent radiating portions (3a-d) are formed substantially perpendicularly relative each other.

18. A dual-band antenna element arrangement comprising an antenna element (1) according to any of the preceding claims being configured to transmit and receive signals within one or more first frequency bands, and a high-band antenna element (10) configured to transmit and receive signals within one or more second frequency bands being higher than said one or more first frequency bands, wherein the high-band antenna element comprises radiating portions (10a-d) and is arranged substantially at a center of the antenna element (1) at least partly within a space defined by the antenna element body (2) of the antenna element.

19. Dual-band antenna element arrangement according to claim 18, wherein the high-band antenna element (10) is arranged at a bottom of the antenna element body (2).

20. Dual-band antenna element arrangement according to any of claims 18-19, wherein the high-band antenna element (10) is formed as two perpendicular dipoles (10a, 10c, 10b, 10d).

21. Dual-band antenna element arrangement according to any of claims 18-20, wherein the slots (6a-d) of the antenna element (1) are configured in relation to the high-band antenna element (10) such that a horizontal area projection of the high-band antenna element onto the antenna element is non-overlapping with the slots.

22. An antenna arrangement comprising a backplane (11), a plurality of antenna elements according to any of claims 1-17 and/or dual band antenna element arrangements (1, 1′, 10, 10′) according to any of claims 18-21 arranged in front of said backplane, and an antenna feeding network (12) electrically connected to the antenna elements and/or dual-band antenna element arrangements.

23. Antenna arrangement according to claim 22, wherein said antenna feeding network (12) comprises transmission lines (12a-c) being capacitively and/or inductively interconnected, said transmission lines being capacitively and/or inductively connected to the antenna elements and/or dual-band antenna element arrangements.

24. Antenna arrangement according to claim 22 or 23, wherein said dual-band antenna element arrangements (1, 1′, 10, 10′) are arranged in relation to said backplane (11) such that the radiating portions of the high-band antenna element (10) are disposed at a distance (B) above the backplane which is less than 75% of the distance (A) between the radiating portions of the antenna element (1) and the backplane.

25. Antenna arrangement according to any of claims 22-24, wherein the central conductor of the antenna feeding network does not have any galvanic joints.
